(19) United States
(12) Patent Application Publication
(10) Pub. No.: US 2019/0240890 A1
(43) Pub. Date: Aug. 8, 2019

(54) PROCESS FOR PRODUCING HOLLOW RESIN-MOLDED ARTICLE, AND FUEL TANK

(71) Applicant: HONDA MOTOR CO., LTD., Tokyo (JP)

(72) Inventors: Takeharu YOSHIHASHI, Wako-shi (JP); Kotaro TANAKA, Wako-shi (JP); Masaki WAKAO, Wako-shi (JP); Susumu MURAYAMA, Wako-shi (JP); Nao SATO, Wako-shi (JP); Toshiharu FUKUSHIMA, Wako-shi (JP)

(21) Appl. No.: 16/266,317

(22) Filed: Feb. 4, 2019

(30) Foreign Application Priority Data
Feb. 6, 2018 (JP) 2018-019057

(51) Int. Cl. B29C 49/20; B29C 49/00; B29C 49/48; B60K 15/03

(52) U.S. Cl. CPC B29C 49/20; B29C 49/0047; B29C 49/4802; B29K 2105/256; B29C 2049/0057; B29C 2049/2017; B29C 2049/4805; B60K 15/03177

(57) ABSTRACT

A process of producing a hollow resin-molded article includes: arranging covers on inner walls of mold halves, the covers having shapes corresponding to the inner walls; introducing a pair of sheets of thermoplastic resin each facing the cover arranged on the inner wall of a corresponding mold half; blowing air into a space between the sheets to cause the sheets to respectively contact the covers arranged on the inner walls, and thereby fusion-welding the sheets to the covers; and closing the mold halves; and cooling down the covers and the sheets in a state where the mold halves are closed. In the step of arranging, there are uncovered portions of the inner walls that are not covered by the cover. In the step of closing, there are mold contact portions of the sheets that respectively contact the uncovered portions directly and the mold contact portions are fusion-welded to each other in an overlapping manner.

### CROSS-REFERENCE TO RELATED APPLICATIONS

The present application claims priority under 35 U.S.C. § 119 to Japanese Patent Application No. 2018-019057, filed on Feb. 6, 2018, the contents of which are hereby incorporated by reference in their entirety.

### BACKGROUND OF THE INVENTION

### 1. Field of the Invention

The present invention relates to a process of producing a hollow resin-molded article using a thermoplastic resin and to a fuel tank.

### 2. Description of Related Art

In an automobile fuel tank produced using a thermoplastic resin (hereinafter referred to as resin as appropriate), a tank body containing fuel expands due to the evaporation of the fuel. To inhibit such expansion of the tank body, an outer surface of the tank body can be covered with a cover made of fiber-reinforced plastic.

Japanese Patent Application Publication No. 2009-1048 and Japanese Patent Publication No. 5608287 describe examples of such a tank body with an outer surface covered by a cover.

In either process described in Japanese Patent Application Publication No. 2009-1048 and Japanese Patent Publication No. 5608287, a premolded cover is arranged on a mold and then blow molding of a parison is performed. This process presses a high-temperature parison onto the cover arranged on the mold to mold a tank body made of the parison. When the high-temperature parison is pressed onto the cover, a portion of the cover that contact the parison melts, so the cover and the tank body (parison) are fusion-welded to each other. As a result, the rigidity of the fuel tank can be increased.

### SUMMARY OF THE INVENTION

### Problems to be Solved by Invention

However, when blow molding the tank body with two sheet-like parisons, the tank body has a portion where the two sheet-like parisons overlap with each other, so that the tank body has an increased thickness in such a portion. In such a portion where the overlapped parisons have a large thickness, the cooling efficiency is reduced and thus the parisons are inhibited from being cooled. In addition, when the cover covers such a portion where the overlapped parisons have a large thickness, the cooling efficiency is further reduced due to the cover. In other words, the time for drawing heat is increased. Japanese Patent Application Publication No. JP 2009-1048 and Japanese Patent Publication No. 5608287 are silent with respect to such consideration.

The present invention has been made in view of the above background, and it is an object of the present invention to shorten the time for molding the thermoplastic resin.

### Solution to Problem

To solve the above-described problem, an aspect of the present invention is a process of producing a hollow resin-molded article using a mold comprising a pair of mold halves, the method including steps of: arranging a cover on an inner wall of each of the pair of mold halves, the cover being premolded and having a shape corresponding to the inner wall; introducing a thermoplastic resin fusion-weldable to the cover into an inner space between the pair of mold halves so as to form a pair of sheets of thermoplastic resin each facing the cover arranged on the inner wall of corresponding one of the pair of mold halves; blowing air into an intermediate space between the pair of sheets of thermoplastic resin to cause each of the pair of sheets of thermoplastic resin to contact the cover arranged on the inner wall of corresponding one of the pair of mold halves, and thereby fusion-welding each of the pair of sheets of thermoplastic resin to the cover arranged on the inner wall of corresponding one of the pair of mold halves; closing the pair of mold halves; and cooling down the covers and the pair of sheets of thermoplastic resin in a state where the pair of mold halves is closed. The covers and the pair of mold halves are configured such that, in the step of arranging the cover, there is an uncovered portion of the inner wall of each of the pair of mold halves that is not covered by the corresponding cover, and that, in the step of closing the pair of mold halves, there is a mold contact portion of each of the pair of sheets of thermoplastic resin that directly contacts the uncovered portion of the inner wall of corresponding one of the pair of mold halves and the mold contact portions of the pair of sheets of thermoplastic resin are fusion-welded to each other in an overlapping manner.

Another aspect of the present invention is a fuel tank including: a tank body formed of a plurality of sheets of thermoplastic resin; and a cover arranged to cover the tank body, the cover being fusion-weldable to a surface of the tank body by heat. The tank body has an overlapping portion where two of the plurality of sheets of thermoplastic resin are overlapped with each other and fusion-welded to each other. The overlapping portion has a portion not covered by the cover.

Other aspects of the solution will be described in the description of embodiments as appropriate.

### Advantageous Effect of the Invention

According to the present invention, the time for molding a thermoplastic resin can be shortened.

### BRIEF DESCRIPTION OF THE DRAWINGS

FIG. 1 is a perspective view of a fuel tank F according to an embodiment.

FIG. 2 is another perspective view of the fuel tank F according to the present embodiment.

FIG. 3 is a schematic cross-sectional view of the fuel tank F according to the present embodiment.

FIG. 4 is a schematic cross-sectional view of the fuel tank F in a mold 12.

FIG. 5 is a diagram for explaining a cover arranging step.

FIG. 6 is a diagram for explaining a parison introducing step and a blow molding step.

FIG. 7 is a diagram for explaining the parison introducing step and the blow molding step to be performed subsequent to the process shown in FIG. 6.

FIG. 8 is a diagram for explaining a cooling step.

FIG. 9 is a diagram for explaining an extraction step.

### DETAILED DESCRIPTION OF EMBODIMENTS

Next, an embodiment for carrying out the present invention will be described in detail with reference to the drawings as appropriate.

### Fuel Tank F

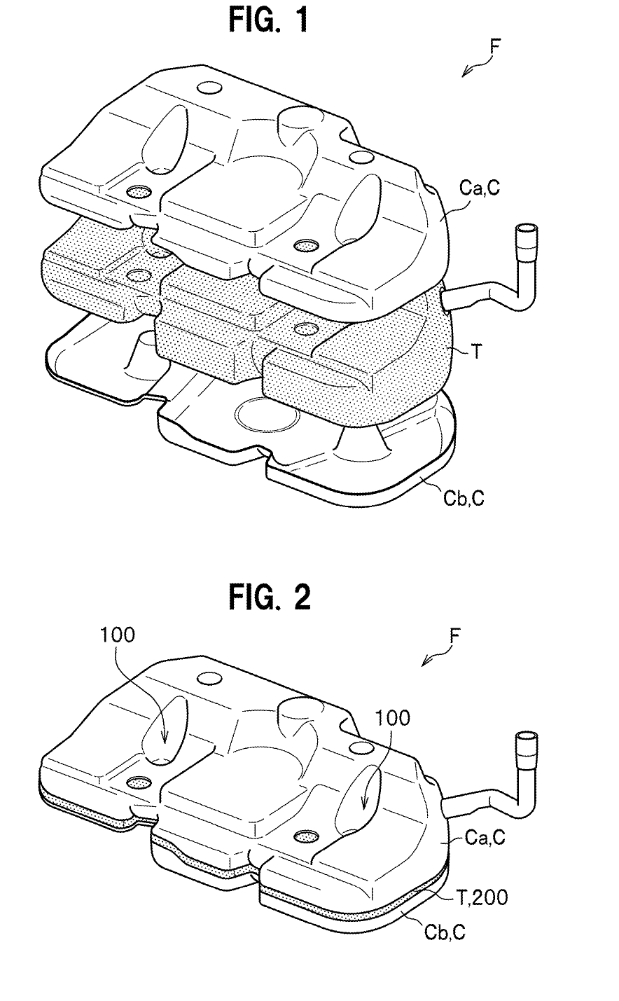

FIGS. 1 and 2 are each a perspective view of an example of a fuel tank F according to the present embodiment.

FIG. 1 illustrates a state where a tank body T and cover C of the fuel tank F are separated from each other. FIG. 2 illustrates a state where the cover C have been fusion-welded to the tank body T.

As shown in FIG. 1, the fuel tank F, which is a resin-molded article, includes the tank body T and the cover C. The cover C is made of a reinforced plastic such as a fiber-reinforced plastic (thermoplastic resin) that can be fusion-welded to an outer skin layer of the tank body T. Incidentally, the tank body T is indicated by the dot hatching pattern in FIGS. 1 and 2.

As described above, the cover C is disposed to inhibit the tank body T from expanding due to the evaporation of the fuel in the tank body T. In FIG. 1, the tank body T and the cover C are illustrated as being separate from each other. In an actual state, however, the tank body T and the cover C are fusion-welded to each other as shown in FIG. 2. As described above, the tank body T and the cover C are fusion-welded to each other to increase the rigidity of the fuel tank F. As shown in FIGS. 1 and 2, the cover C is made up of an upper cover Ca and a lower cover Cb.

As shown in FIG. 2, the fuel tank F has two standoff portions 100 for enhancing the strength of the fuel tank F. Each standoff portion 100 is made up of concavities respectively formed on an upper wall and a lower wall of the tank body T and having respective lower surfaces abutting each other inside an accommodation space of the tank body T. Those concavities are formed by depressing the upper wall and the lower wall from the outside of the tank body T toward inside thereof so that the respective lower surfaces of the formed concavities abut each other inside the accommodation space. The standoff portions 100 with such a structure are formed for the purpose of increasing the rigidity of the fuel tank F.

It should be noted that the tank body T is molded from two sheet-like parisons (thermoplastic resin).

As shown in FIG. 2, in a state where the cover C has been fusion-welded to the tank body T, the fuel tank F has an outer periphery portion where a pinched-off portion 200 of the tank body T is exposed between the upper cover Ca and the lower cover Cb. The pinched-off portion 200 will be described later. Incidentally, in FIG. 2, the tank body T is exposed substantially the entire length along the outer periphery portion of the fuel tank F. However, the tank body T may be partially exposed from the outer periphery portion of the fuel tank F.

### Schematic Cross Section of Fuel Tank F

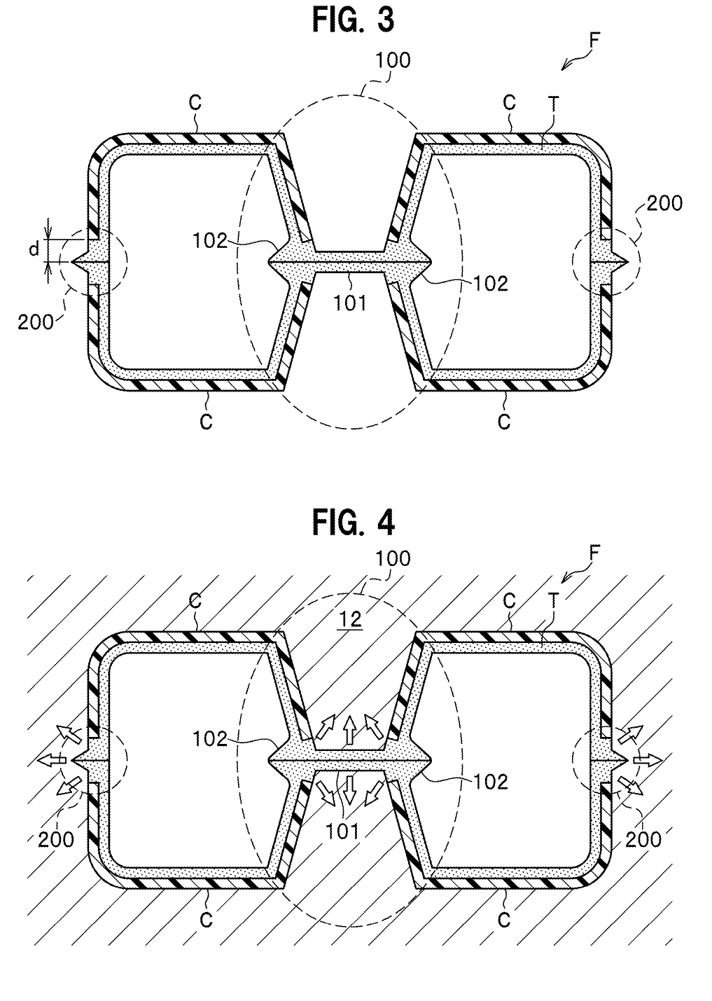

FIG. 3 is a schematic cross-sectional view of the fuel tank F according to the present embodiment. FIG. 4 is a schematic cross-sectional view of the fuel tank F in a mold 12.

The fuel tank F illustrated in FIGS. 3 and 4 has a single standoff portion 100 at a central location of the fuel tank F, unlike the fuel tank F illustrated in FIGS. 1 and 2. The fuel tank F has a periphery portion where the pinched-off portion 200 is formed.

Incidentally, of the constituent elements shown in FIG. 4, those having the same configuration as in FIG. 3 are given the same signs and duplicated descriptions thereof are omitted. In FIGS. 3 and 4, the solid line in the tank body T indicates an interface where the two parisons abut each other. In an actual state, however, they have been fusion-welded to each other at the interface.

### Standoff Portion 100

The standoff portion 100 includes a fusion-welded portion 101 where the parison of the upper bottom surface is overlapped with the parison of the lower bottom surface.

The standoff portion 100 includes bulge portions 102 that are formed of the parisons pushed out inside the tank body T.

Tank body T has a larger thickness at the fusion-welded portion 101 and the bulge portions 102 than other portion of the tank body T because two parisons are overlapped with each other in the fusion-welded portion 101 and the bulge portions 102. For this reason, the cooling efficiency in the fusion-welded portion 101 and the bulge portions 102 can be reduced. In addition, if the fusion-welded portion 101 and pinched-off portion 200 thus structured are covered with the cover C, the cooling efficiency is further reduced.

In the present embodiment, as shown in FIG. 3, the fusion-welded portion 101, the bulge portions 102 and periphery portions thereof are not covered with the cover C. With this structure, as shown in FIG. 4, the fusion-welded portion 101 and the bulge portions 102, which have a large thickness, are directly in contact with the mold 12 without the cover C interposed therebetween. As a result, the heat in the fusion-welded portion 101 and the bulge portions 102 escapes directly to the mold 12 (outlined arrows). Therefore, the structure facilitates cooling the fusion-welded portion 101 and the bulge portions 102.

### Pinched-Off Portion 200

As shown in FIG. 3, the two parisons are overlapped with each other in the pinched-off portion 200, and thus the pinched-off portion 200 has a large thickness than another portion of the tank body T where the two parisons are not overlapped. Like the standoff portion 100, the cooling efficiency of the pinched-off portion 200 thus structured is low. In addition, if the pinched-off portion 200 thus structured is covered with the cover C, the cooling efficiency is further reduced.

Taking this into account, as shown in FIG. 3, the pinched-off portion 200 and its periphery portion are not covered with the cover C. With this structure, as shown in FIG. 4, the pinched-off portion 200 is directly in contact with the mold 12 without the cover C interposed therebetween. As a result, the heat in the pinched-off portion 200 escapes directly to the mold 12 as indicated by the outlined arrows in FIG. 4. Therefore, the structure facilitates cooling the pinched-off portion 200.

Incidentally, a distance d from a center portion of the pinched-off portion 200 to an end of the cover C, which is shown in FIG. 3, is 10 mm, for example. The value of the distance d is not limited thereto and may be selected to one such that the portion of the tank body T with the larger thickness is not covered by the cover C. This also applies to the standoff portion 100. The standoff portion 100 and pinched-off portion 200 may have respective different values of the distance d.

Incidentally, in the present embodiment, the standoff portion 100 and the pinched-off portion 200 are not covered entirely by the cover C. However, the fuel tank F may be configured so that the tank body T has at least a portion not covered by the cover C in each of the standoff portion 100 and the pinched-off portion 200. In other words, the fuel tank F may be configured so that the tank body T has at least a portion that is directly in contact with the mold 12 in each of the standoff portion 100 and the pinched-off portion 200. For example, each of the standoff portion 100 and the pinched-off portion 200 may be covered by a portion of the cover C having holes in a spotted pattern.

As described above, the cover C is disposed to inhibit the tank body T from expanding due to the evaporation of the fuel in the tank body T. However, as described above, the standoff portion 100 and the pinched-off portion 200 have a larger thickness than another portion of the tank body T. Therefore, the tank body T is inhibited from expanding due to the evaporation of the fuel despite that the standoff portion 100 and the pinched-off portion 200 are not covered by the cover C.

### Process for Molding Fuel Tank F

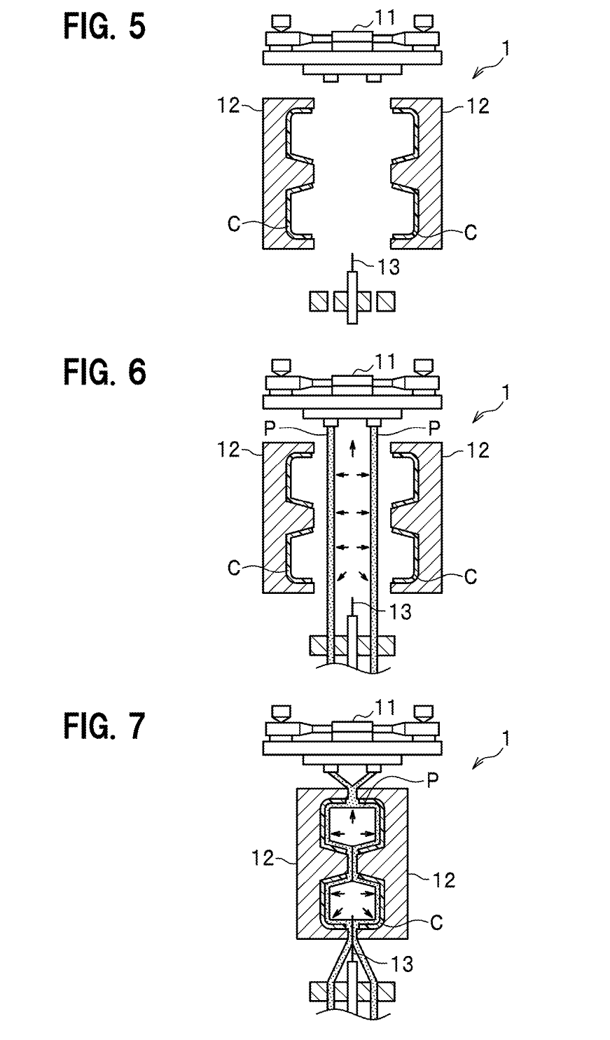

Next, a description will be given of a process for producing the fuel tank F according to the present embodiment with reference to FIGS. 5 to 9.

Referring to FIGS. 5 to 9, a blow molding device 1 has a dice 11, a pair of molds 12, and an air pin 13.

The dice 11 discharges a pair of parisons P (thermoplastic resin; see FIG. 6) extruded from an extrusion device not shown into a space between the pair of molds 12, in the form of two sheets. Preferably, the pair of parisons P has a temperature of 160° C. to 190° C., or more preferably 180° C. to 190° C.

An air supply device not shown supplies compressed air via the air pin 13 into a space between the pair of parisons P. As a result, the pair of parisons P expands. The expanded pair of parisons P are pressed against the pair of molds 12, whereby a resin tank body T is molded (blow molded).

Incidentally, in the embodiment shown in FIGS. 5 to 9, the tank body T (see FIG. 2) and the cover C are each arranged in a vertical orientation.

### Cover Arranging Step

FIG. 5 illustrates a step of arranging covers.

First, as shown in FIG. 5, cover C having been molded in advance is arranged on inner sides of the pair of molds 12. The cover C has a shape corresponding to the external shape of the tank body T to be molded (has a shape corresponding to the shape of the pair of molds 12). In other words, the cover C is fitted onto the pair of molds 12. The cover C may be arranged by a manipulator not shown or manually.

### Parison Introducing Step and Blow Molding Step

FIGS. 6 and 7 respectively illustrate a parison introducing step and a blow molding step.

As shown in FIG. 6, for example, a pair of parisons P in a melted state is discharged from the dice 11 in the form of two sheets (parison introducing step). A step of sandwiching the discharged pair of parisons P by the left and right pair of molds 12 is started together with the parison introducing step. Concurrently with the sandwiching step, a blow molding step in which compressed air is supplied into a space between the pair of parisons P via the air pin 13 is carried out (see the solid lines in FIG. 6). In this way, the pair of parisons P expands, and the pair of parisons P having expanded is pressed against the pair of molds 12 (cover C) (see FIG. 7). It should be noted that, although two sheet-like parisons are discharged in this embodiment, three or more sheet-like parisons or a cylindrical parison may be discharged. Moreover, a single sheet-like parison may be discharged into a cylindrical form.

Incidentally, the temperature of the pair of molds 12 is a normal temperature (approximately 26° C.).

FIG. 7 illustrates the blow molding step in which the sandwiching step has been completed.

As shown in FIG. 7, completion of the sandwiching step causes upper and lower portions of the pair of parisons P to be closed. As shown in FIG. 7, even after the completion of sandwiching, the compressed air is supplied into the space between the pair of parisons P for a predetermined time via the air pin 13 (see solid line arrows in FIG. 7). In FIG. 7, the hollow space between the pair of parisons P appears to be partitioned by the standoff portion 100. However, as shown in FIG. 1, the hollow space extends continuously around the standoff portion 100, in the actual shape. Thus, when air is supplied into one side of the hollow space as shown in FIG. 7, the air is also supplied into the other side.

When the pair of parisons P contacts the cover C, a portion of the cover C that is in contact with the corresponding parison P melts. As a result, the tank body T (pair of parisons P) and the cover C are fusion-welded to each other. The melting point of the reinforced plastic of which the cover C is made is 130° C. Incidentally, this blow molding step also serves as the next cooling step.

### Cooling Step

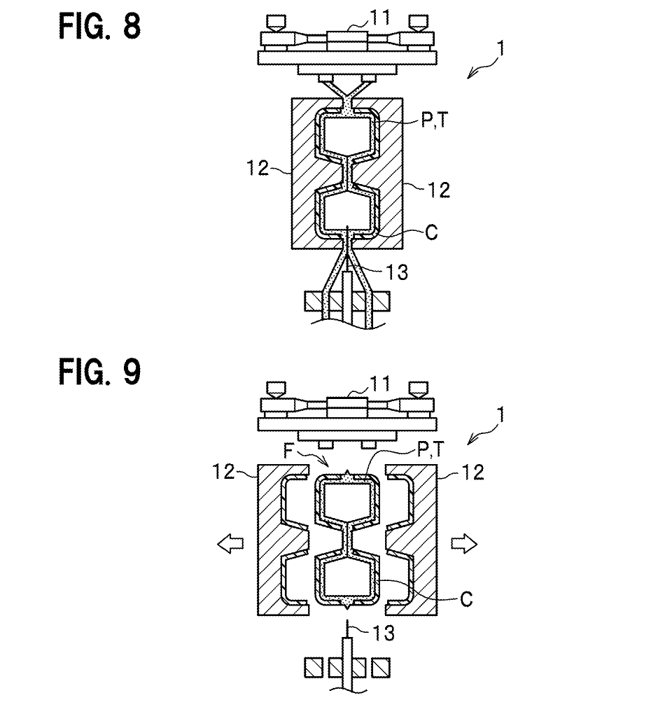

FIG. 8 illustrates a cooling step.

In the blow molding step, after the compressed air is supplied for a predetermined time period, the supply of the compressed air is stopped. Then, the air pin 13 is withdrawn out of the pair of parisons P by being lowered down. The hole that has been formed in the tank body T by the presence of the air pin 13 is automatically closed because the pair of parisons P are in a plastic state. In this state, the standoff portion 100 and the pinched-off portion 200 are directly in contact with the pair of molds 12, which facilitates drawing heat from the pair of parisons P and thus shortens the time for cooling down.

This state shown in FIG. 8 is maintained for a certain time to cool down the pair of parisons P. The cooling down step may be carried out in a normal temperature environment, or may be carried out by blowing cooling air to the outer side of the cover C via not-shown cooling holes of the molds 12.

It should be noted that, in the present embodiment, the compressed air is supplied for a predetermined time period, and, after the supply of the compressed air is stopped, the cooling step is started. However, the blow molding step and the cooling step may be carried out concurrently. In other words, the supply of the compressed air may be continued until the pair of parisons P (tank body T) and the cover C, which have been fusion-welded to each other, have been cooled down.

### Extraction Step

FIG. 9 illustrates an extraction step.

When a predetermined time period has elapsed and the surface temperature of the cover C has dropped down to a temperature of approximately 70° C. or less, the fuel tank F (cover C and tank body T) is extracted by opening the molds 12 in the directions indicated by the outlined arrows in FIG. 9.

As described above, each of the standoff portion 100 and the pinched-off portion 200 has an overlapping portion where a portion of the parison P molded in one of the molds 12 and a portion of the parison P molded in the other one of the molds 12 are overlapped with each other. Such an overlapping portion has a larger thickness due to the overlapping of the pair of parisons P and thus the cooling speed of the pair of parisons P is slower than another portion where the pair of parisons is not overlapped with each other. Moreover, if the cover C covers such an overlapped portion, the cooling speed further decreases because the total thickness of the overlapping portion is increased due to the thickness of the cover C. Moreover, as the cover C itself has thermal insulation properties, the cooling efficiency decreases.

Configuring the cover C so as not to cover the overlapping portions of the pair of parisons P allows the overlapping portions having a larger thickness to directly contact the molds 12. This structure facilitates drawing heat from the pair of parisons P to shorten the time for cooling down. As a result, the production time of the fuel tank F can be shortened.

In addition, as the cover C does not entirely cover the pair of parisons P, the fuel tank F including the pair of parisons P is reduced in weight and cost.

Moreover, in the present embodiment, the cover Cis not present on the standoff portion 100 and the pinched-off portion 200. With this structure, the cover C can be configured so as not to be present on the overlapping portion where the plural parisons P are overlapped with each other in blow molding due to the structure of the molds 12.

In particular, the application of the embodiment to the fuel tank F achieves weight reduction and cost reduction of the fuel tank F while inhibiting expansion of the tank body T by the cover C. In addition, the tank body T has a large thickness of the overlapping portions where the pair of parisons P is overlapped with each other. For this reason, the expansion of the tank body T is inhibited even the overlapping portions are not covered by the cover C.

As shown in FIG. 3, in the present embodiment, both the upper cover Ca and the lower cover Cb partially cover the upper portion and the lower portion of the tank body T, respectively. However, the present invention is not limited to this. For example, the fuel tank F may be such that either of the upper cover Ca side and the lower cover Cb side has a portion where the tank body T is exposed. In addition, in the present embodiment, each of the standoff portion 100 and the pinched-off portion 200 has a portion where the tank body T is exposed as shown in FIG. 3. However, the present invention is not limited to this. For example, the fuel tank F may be configured so that the tank body T is exposed at either the standoff portion 100 or the pinched-off portion 200.

Moreover, the pair of molds 12 may have suction holes through which air in the space between the pair of molds 12 is suctioned. Then, when the cover C is being arranged on the molds 12, the cover C may be fixed to the pair of molds 12 by the air suctioned through the suction hole.

What is claimed is:

1. A process of producing a hollow resin-molded article using a mold comprising a pair of mold halves, the method comprising steps of:
arranging a cover on an inner wall of each of the pair of mold halves, the cover being premolded and having a shape corresponding to the inner wall;
introducing a thermoplastic resin fusion-weldable to the cover into an inner space between the pair of mold halves so as to form a pair of sheets of thermoplastic resin each facing the cover arranged on the inner wall of corresponding one of the pair of mold halves;
blowing air into an intermediate space between the pair of sheets of thermoplastic resin to cause each of the pair of sheets of thermoplastic resin to contact the cover arranged on the inner wall of corresponding one of the pair of mold halves, and thereby fusion-welding each of the pair of sheets of thermoplastic resin to the cover arranged on the inner wall of corresponding one of the pair of mold halves;
closing the pair of mold halves; and
cooling down the covers and the pair of sheets of thermoplastic resin in a state where the pair of mold halves is closed,
wherein the covers and the pair of mold halves are configured such that, in the step of arranging the cover, there is an uncovered portion of the inner wall of each of the pair of mold halves that is not covered by the corresponding cover, and that, in the step of closing the pair of mold halves, there is a mold contact portion of each of the pair of sheets of thermoplastic resin that directly contacts the uncovered portion of the inner wall of corresponding one of the pair of mold halves and the mold contact portions of the pair of sheets of thermoplastic resin are fusion-welded to each other in an overlapping manner.

2. The method of claim 1,
wherein the uncovered portion of the inner wall of each of the pair of mold halves is located on a parting line between the pair of mold halves, and
wherein the method further comprises pinching off the pair of sheets of thermoplastic resin along the parting line.

3. The method of claim 1,
wherein the pair of sheets of thermoplastic resin is respectively first and second sheets of thermoplastic resin,
wherein, in the step of introducing the thermoplastic resin, the first and second sheets of thermoplastic resin are formed to be opposite to each other with the intermediate space therebetween,
wherein the step of blowing air causes the first sheet and the second sheet to be respectively pressed against the inner walls of the pair of mold halves from an inner side of the intermediate space toward an outer side thereof so that a first portion of the first sheet of thermoplastic resin and a second portion of the second sheet of thermoplastic resin are respectively deformed into a first concavity with a first bottom wall portion and a second concavity with a second bottom wall portion in accordance with shapes of the respective inner walls of the pair of mold halves,
wherein the step of closing the mold halves causes the first bottom wall portion and the second bottom wall portion to abut each other and to be fusion-welded to each other in the intermediate space, and
wherein the first bottom wall portion includes the mold contact portion of the first sheet of thermoplastic resin and the second bottom wall portion includes the mold contact portion of the second sheet of thermoplastic resin.

4. The method of claim 2,
wherein the hollow resin-molded article produced by the method is a fuel tank.

5. The method of claim 3,
wherein the hollow resin-molded article produced by the method is a fuel tank.

6. A fuel tank comprising:
a tank body formed of a plurality of sheets of thermoplastic resin; and
a cover arranged to cover the tank body, the cover being fusion-weldable to a surface of the tank body by heat,
wherein the tank body has an overlapping portion where two of the plurality of sheets of thermoplastic resin are overlapped with each other and fusion-welded to each other, and
wherein the overlapping portion has a portion not covered by the cover.

7. The fuel tank according to claim 6,
wherein the overlapping portion is a pinched-off portion where the two of the thermoplastic resin have been pinched off by a mold.

8. The fuel tank according to claim 6,
wherein the tank body includes: an upper wall with an upper concavity; and a lower wall with a lower concavity,
wherein a lower bottom wall portion of the upper concavity and a lower bottom wall portion of the lower concavity abut each other and are fusion-welded to each other in an inner space of the tank body, and
wherein the overlapping portion comprises the lower bottom wall portion of the upper concavity and the lower bottom wall portion of the lower concavity.
